(19) United States
(12) Patent Application Publication
(10) Pub. No.: US 2004/0125929 A1
(43) Pub. Date: Jul. 1, 2004

(54) Projection caller ID

(76) Inventor: Stephen M. Pope, Shawnee, KS (US)

Correspondence Address: CHASE & YAKIMO, L.C., 4400 COLLEGE BOULEVARD, SUITE 130, OVERLAND PARK, KS, 66211

(21) Appl. No.: 10/334,258

(22) Filed: Dec. 31, 2002

(51) Int. Cl. H04M 1/56; H04M 15/06

(52) U.S. Cl. 379/142.17

(57) ABSTRACT

A projection caller ID system includes a caller ID display and controls and a projection arm to project caller ID data including caller name and number onto a surface such as a wall or ceiling. The projection arm includes a slave transparent LCD which is illuminated by LEDs to project an image of the caller ID data through a lens onto a surface. The projection caller ID system allows the caller ID data to be read from a distance from the caller ID unit and in a low light or dark environment as well as a normal ambient light environment.

### BACKGROUND OF THE INVENTION

The present invention relates to data projection systems, and more particularly, to a system to project caller identification (caller ID) information onto a wall or ceiling.

Caller ID is a service offered by telephone companies, which allows a calling party's number to be displayed on a caller ID box. Additional information such as the caller's name, time and date of the call may also be displayed. Caller ID allows the called party to know who the caller is before answering the call, to screen calls, and to review calls received. One problem with prior art caller ID boxes is the calling party's telephone number and name is typically displayed on a relatively small liquid crystal display (LCD) which must be viewed at a proper angle to read the display and at a close distance to the display. Additionally, in a low light environment, the LCD is more difficult to read.

### SUMMARY OF THE INVENTION

The present invention provides a caller ID box with a projection system to project the caller ID information onto a wall or other surface such as a ceiling. The projection system includes a slave liquid crystal display (LCD) and high-intensity light emitting diodes (LED) or other light source to project the caller ID information through a lens and onto a surface.

Other advantages of this invention will become apparent from the following description taken in connection with the accompanying drawings, wherein is set forth by way of illustration and example, a preferred embodiment of the present invention.

### BRIEF DESCRIPTION OF THE DRAWINGS

FIG. 1 is a plan view of the projection caller ID system of the present invention.

FIG. 2 is a side elevation view of the projection caller ID system FIG. 1 with the projection tube pivoted upwardly to project caller ID data on a wall surface.

FIG. 3 is a side elevation view of the projection caller ID system of FIG. 1 with the projection tube pivoted upwardly to project caller ID data on a ceiling surface.

FIG. 4 is a front elevation view of the projection caller ID system of FIG. 2.

FIG. 5 is a diagrammatic electrical schematic of the projection caller ID system.

FIG. 6 is a diagrammatic view of the components of the projection caller ID projection arm.

### DETAILED DESCRIPTION

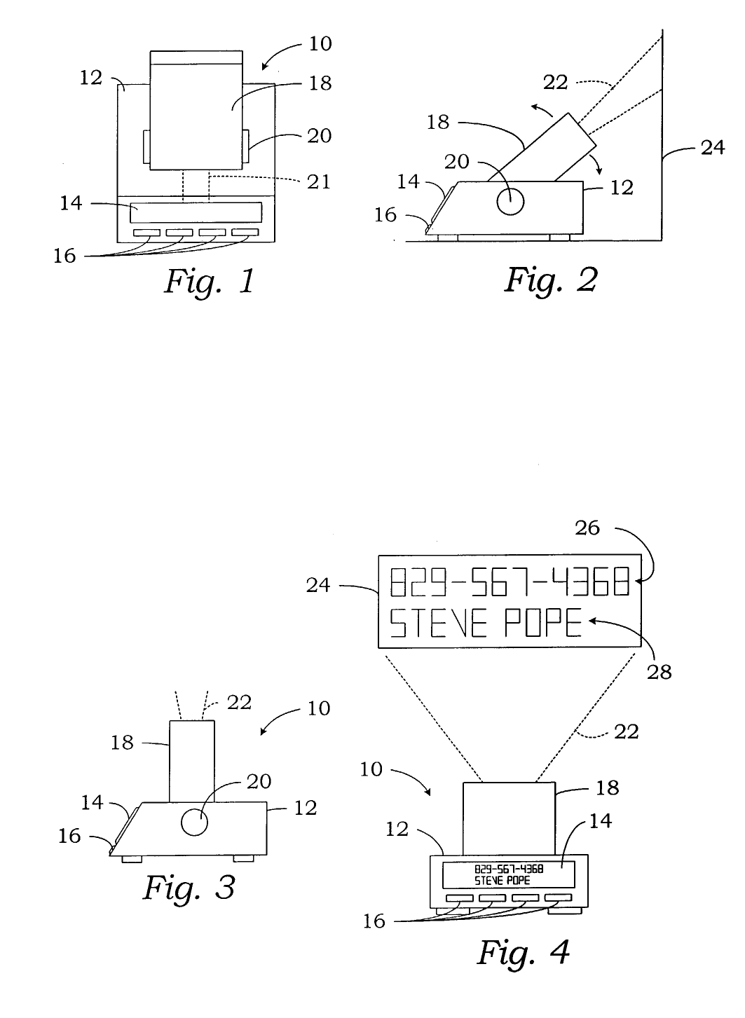

Referring to FIG. 1, the projection caller ID system of the present invention is generally indicated by reference numeral 10. Projection caller ID system 10 includes a main housing 12, a main display 14, control buttons 16, and a projection housing 18. Projection caller ID system 10 includes a telephone line input and a telephone line output which may be connected to a telephone or an answering machine in series (not shown).

Projection housing or arm 18 is pivotally connected to housing 12 via a pivot 20. A ribbon cable or other electrical wires 21 connects the electrical components of the housing 12 to the components of the projection housing 18. Projection arm 18 may be pivoted (FIGS. 2 and 3) such that light 22 emitted from the end of projection arm 18 may be directed to a wall 24 or ceiling (not shown).

Referring to FIG. 4, the light 22 emitted from projection housing 18 includes a projection of the caller ID information 24 which may include the telephone number 26 and the name of a caller 28.

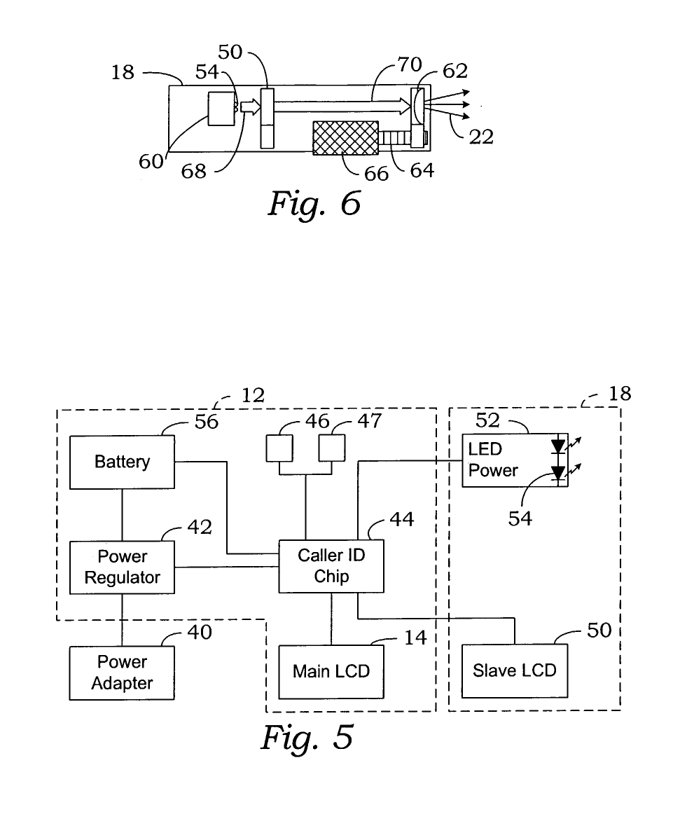

Referring to FIG. 5, a circuit block diagram for the projection caller ID system is illustrated. A power adapter 40 supplies 12 volt-DC power to regulator 42, which powers caller ID chip 44. Caller ID chip 44 receives caller ID data from telephone input jack 46 which is displayed on the main LCD 14. The name and number data is sent by the caller ID chip 44 to the slave LCD 50 to be projected. The slave LCD 50 displays the same name and number data as is displayed on the main LCD 14.

Caller ID chip 44 enables LED power source 52 to illuminate LEDs 54. The system may also include a backup battery 56 to retain caller ID data if power from power adapter 40 is interrupted. Two high-intensity LEDs 54 spaced approximately 1.5 mm apart and four mm from the slave LCD 50, may be used to illuminate slave LCD 50. Because of the width of the slave LCD 50, a single LED may not uniformly illuminate all of the characters of the name 28 or number 26, or with enough intensity. However, other light sources such as Tungsten or Halogen lamps, or a laser may be used for an even brighter projection, but in order to make this work, the lamp is accessible through a door panel and easily removable when needing replacement.

Referring to FIG. 6, projection arm 18 includes a LED block assembly 60, which houses LEDs 54, slave LCD 50 and projection lens 62. The projection lens 62 is interconnected by a threaded rod 64 and a focus knob 66. Focus knob 66 may be used to rotate threaded rod 64 to manually change the distance between the slave LCD 50 and the projection lens 62 to focus the emitted light 22 and thus the caller ID information 24 onto a surface.

Projection lens 62 may be 10-30 mm in diameter with a focal length of 25-60 mm, for example. An anti-reflecting coating may be applied to lens 62 to produce a sharper image of caller ID information 24 (FIG. 4) by preventing internal reflections which may distort the image.

Referring to FIGS. 4-6, projection caller ID system 10 is connected via connector 46 to a standard household telephone wall jack (not shown). A telephone (not shown) may be connected to connector 47 of projection caller ID system. When a call is received, caller ID data in the form of the caller's telephone number and name is received by caller ID chip 44. Caller ID chip 44 transfers the caller ID data to main LCD 14, which is displayed in a standard format. Caller ID chip 44 also transfers the caller ID data to slave LCD 50, which is also displayed in a standard format. Caller ID chip 44 enables LED power source 52, which illuminates LEDs 54. Light 68 from LEDs 54 passes through the slave LCD 50. LCD 50 is similar to a transparency for an overhead projector to display the caller ID data. The light 70 which includes the caller ID data is transferred to the projection lens 64 and is projected from projection arm 18. The caller ID information 24 may be focused on a surface such as a wall or ceiling by rotating focus knob 66.

The telephone number 26 and name 28 may be illuminated or may be projected in reverse with the background illuminated and the number 26 and name 28 darkened.

After a predetermined amount of time, caller ID chip 44 blanks the main LCD 14 and the slave LCD 50, and disables LED power source 52 to turn off LEDs 54. Caller ID information 24 may also be displayed when control buttons 16 are used to review previous calls.

It is to be understood that while certain now preferred forms of this invention have been illustrated and described, it is not limited thereto except insofar as such limitations are included in the following claims.

Having thus described the invention, what is claimed as new and desired to be secured by Letters Patent is:

1. A projection caller ID system for displaying caller ID data received from a telephone company, said caller ID system comprising:
a main housing having caller ID controller and a main display electrically connected to said caller ID controller, said caller ID controller for receiving caller ID data and formatting said data for display on said main display,
a projection housing pivotally connected to said main housing and having a transparent slave display, a light source, and a lens, said transparent slave display electrically connected to said caller ID controller and for displaying caller ID data received from said caller ID controller, and
said light source illuminated in response to a control signal received from said caller ID controller, said light source for projecting an image of said caller ID data displayed on said transparent slave display through said lens and out of said housing onto a surface.

2. The projection caller ID system as claimed in claim 1 further comprising means to focus said projected caller ID data on said surface.

3. The projection caller ID system as claimed in claim 1 wherein said light source includes a pair of spaced apart light emitting diodes.

4. The projection caller ID system as claimed in claim 1 wherein said caller ID data includes a caller's name and telephone number.

5. The projection caller ID system as claimed in claim 1 wherein said light source is illuminated for a predetermined period of time.

6. A projection caller ID system for displaying caller ID data received from a telephone company, said caller ID system comprising:
a main housing having caller ID controller and a main display electrically connected to said caller ID controller, said caller ID controller for receiving caller ID data and formatting said data for display on said main display,
a projection housing pivotally connected to said main housing and having a transparent slave display, a pair of spaced apart light emitting diodes, and a lens, said transparent slave display electrically connected to said caller ID controller and for displaying caller ID data received from said caller ID controller, and
said diodes energized in response to a control signal received from said caller ID controller, said diodes for projecting an image of said caller ID data displayed on said transparent slave display through said lens and out of said housing onto a surface.

7. The projection caller ID system as claimed in claim 6 further comprising means to focus said projected caller ID data on said surface.

8. The projection caller ID system as claimed in claim 6 wherein said caller ID data includes a caller's name and telephone number.

9. The projection caller ID system as claimed in claim 6 wherein said diodes are illuminated for a predetermined period of time.

10. A projection caller ID system for displaying caller ID data received from a telephone company, said caller ID system comprising:
a main housing having caller ID controller and a main display electrically connected to said caller ID controller, said caller ID controller for receiving caller ID data and formatting said data for display on said main display,
a projection housing pivotally connected to said main housing and having a light source positioned at a first end of said projection housing, a lens positioned opposite said light source and in front of an opening in said housing, a transparent slave display positioned between said light source and said lens, said transparent slave display electrically connected to said caller ID controller and for displaying caller ID data received from said caller ID controller, and
said light source illuminated in response to a control signal received from said caller ID controller, said light source for projecting an image of said caller ID data displayed on said transparent slave display through said lens and out of said housing onto a surface.

11. The projection caller ID system as claimed in claim 10 further comprising means to focus said projected caller ID data on said surface.

12. The projection caller ID system as claimed in claim 10 wherein said light source includes a pair of spaced apart light emitting diodes.

13. The projection caller ID system as claimed in claim 10 wherein said caller ID data includes a caller's name and telephone number.

14. The projection caller ID system as claimed in claim 10 wherein said light source is illuminated for a predetermined period of time.
